(19) United States
(12) Patent Application Publication
(10) Pub. No.: US 2013/0055281 A1
(43) Pub. Date: Feb. 28, 2013

(54) INFORMATION PROCESSING APPARATUS AND SCHEDULING METHOD

(71) Applicants: Masahiro MIWA, Kawasaki (JP); Akira NARUSE, Machida (JP)

(72) Inventors: Masahiro MIWA, Kawasaki (JP); Akira NARUSE, Machida (JP)

(73) Assignee: FUJITSU LIMITED, Kawasaki-shi (JP)

(21) Appl. No.: 13/591,312

(22) Filed: Aug. 22, 2012

(30) Foreign Application Priority Data
Aug. 29, 2011 (JP) 2011-186058

(51) Int. Cl. G06F 9/46

(52) U.S. Cl. 718/104

(57) ABSTRACT

An information processing apparatus includes a plurality core sections, an uncore section, and a scheduler. The plurality of core sections correspond to processor cores in a multi-core processor. The uncore section is a resource shared by the core sections. The scheduler controls execution timing for a first process so as to make an unused core section execute the first process in a period in which a second process other than the first process is executed by a part of the plurality of core sections. Controlling the execution timing for the first process is permitted.

### CROSS-REFERENCE TO RELATED APPLICATION

This application is based upon and claims the benefit of priority of the prior Japanese Patent Application No. 2011-186058, filed on Aug. 29, 2011, the entire contents of which are incorporated herein by reference.

### FIELD

The embodiments discussed herein are related to an information processing apparatus and a scheduling method.

### BACKGROUND

Recent processors have a mechanism for shifting for power saving to a power saving state in which power consumption is lower at the time of going into an idle state in which there is no process to be executed.

A multi-core processor includes a plurality of core sections and an uncore section which is a resource portion shared by the plurality of core sections. A power saving state of a core section and a power saving state of the uncore section are defined.

When a core section goes into an idle state, it goes into the power saving state. When all of the plurality of core sections which share the uncore section go into an idle state, the uncore section goes into the power saving state. Accordingly, there is a case where a core section included in the multi-core processor is in an idle state and where another core section is operating in that period. In such a case, the uncore section does not go into the power saving state. If this state continues, the uncore section does not shift to the power saving state and power saving is not realized. Therefore, in order to realize power saving, to make the plurality of core sections execute processes at the same time and put the entire multi-core processor into an idle state after the completion of the execution of the processes is proposed (“Energy-Efficient Platforms—Considerations for Application Software and Services” (Whitepaper), Revision 1.0, [online], March 2011, Intel Corporation, (search was made for on August 10, 2011), see URL: http://download.intel.com/technology/pdf/Green_Hill_Softwa re.pdf).

Japanese Laid-open Patent publication No. 09-185589

Japanese Laid-open Patent publication No. 04-215168

In order to execute processes at the same time by a plurality of core sections, it is necessary to control timing at which a process is executed. For example, in a situation in which only one process is executed, the execution of the process is delayed. The process is executed at timing at which another process is executed.

If controlling execution timing for a process in a desktop environment is taken into consideration, it is not appropriate for some of processes executed by a core section of a multi-core processor to arbitrarily control execution timing. For example, there is a user process used for processing, such as interactive processing, performed in response to a request from a user. Usually a user process is executed without any delay at timing requested by a user. However, if execution timing for, for example, a user process is arbitrarily controlled for the purpose of power saving, then a response to a processing request delays and efficiency in processing performed by the use of a user process decreases.

As stated above, if execution timing for a process is controlled regardless of its type for the purpose of power saving, then efficiency in processing, such as interactive processing, to be immediately performed decreases.

### SUMMARY

According to an aspect, there is provided an information processing apparatus including a processor with a plurality of core sections and a scheduler which performs process scheduling for the plurality of core sections, the scheduler controlling execution timing for a first process so as to make an unused core section execute the first process in a period in which a second process other than the first process is executed by a part of the plurality of core sections, controlling the execution timing for the first process being permitted.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of the structure of an information processing apparatus;

FIG. 2 indicates a state of consumption of power in a multi-core processor;

FIG. 3 is a view for describing power saving realized by the simultaneous use of core sections;

FIG. 4 is a view for describing power saving realized by the simultaneous use of core sections;

FIG. 5 is an example of a process in a desktop environment;

FIG. 6 is a view for describing control of timing at which an assist process is executed;

FIG. 7 is a view for describing control of timing at which an assist process is executed;

FIG. 8 is a view for describing the state of deterioration in performance at the time of the occurrence of resource contention;

FIG. 9 is a view for describing the state of deterioration in performance at the time of the occurrence of resource contention;

FIG. 10 is an example of the structure of the information processing apparatus;

FIG. 11 is an example of the structure of an assist process table;

FIG. 12 is an example of the structure of an ordinary process table;

FIG. 13 indicates a flow of examination of the type of a load;

FIG. 14 indicates a flow of scheduling;

FIG. 15 indicates a flow of scheduling;

FIG. 16 is an example of the structure of a table for contention determination;

FIG. 17 indicates a flow of operation performed in a resource contention determination process;

FIG. 18 indicates a flow of operation performed in a resource contention determination process; and

FIG. 19 is an example of the hardware configuration of a computer.

### DESCRIPTION OF EMBODIMENTS

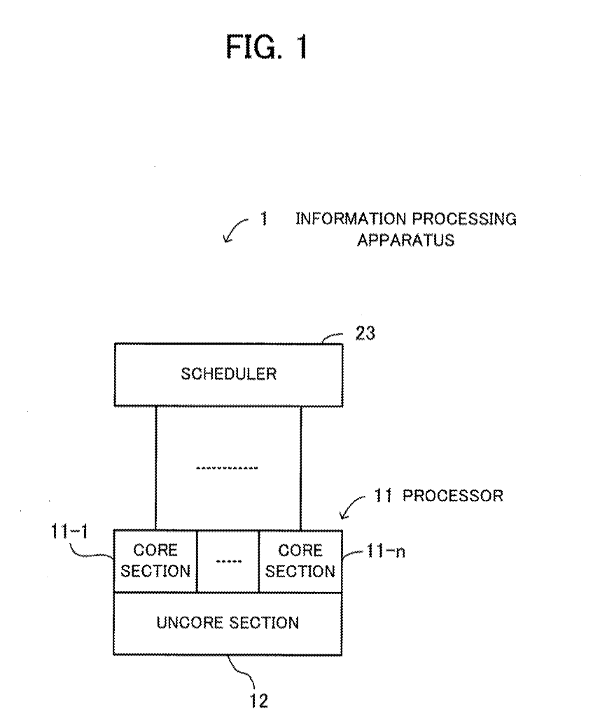

Embodiments will now be described with reference to the accompanying drawings, wherein like reference numerals refer to like elements throughout. FIG. 1 is an example of the structure of an information processing apparatus. An information processing apparatus includes a processor 11 with a plurality of core sections 11-1 through 11-n, an uncore section 12, and a scheduler 23.

The core sections 11-1 through 11-n correspond to processor cores in a multi-core processor. The uncore section 12 is a resource shared by the core sections 11-1 through 11-n, and is a cache memory, memory controller, or the like.

The scheduler 23 performs process scheduling for the core sections 11-1 through 11-n. A first process is designated in the scheduler 23. Controlling the timing at which the first process is executed is permitted. For example, the first process is a process for performing processing, such as a virus scan, the immediate execution of which is not required. The scheduler 23 controls the timing at which the first process is executed so as to make an unused core section execute the first process in a period for which a second process other than the first process is executed by a part of the core sections 11-1 through 11-n. For example, the second process is a process for performing processing, such as interactive processing, the immediate execution of which is required.

When one of the core sections 11-1 through 11-n operates and the other core sections are unused (in an idle state, for example), the uncore section 12 is in an active state and is not in a power saving state.

To be concrete, a power saving state is a state in which all the core sections are stopped by stopping the supply of an operation clock, a state in which the uncore section is stopped by flushing a cache memory, or the like.

Accordingly, with the information processing apparatus 1 the timing at which the first process is executed is controlled so as to make an unused core section execute the first process in a period for which the second process is executed by a part of the core sections 11-1 through 11-n.

This makes it possible to properly control timing at which a process is executed and to make the core sections 11-1 through 11-n execute processes at the same time. As a result, time for which the uncore section 12 is in an active state can be reduced and power saving can be realized efficiently.

Furthermore, it is possible to keep the uncore section 12 in the power saving state for a longer time. As a result, the power consumption of the processor can be reduced.

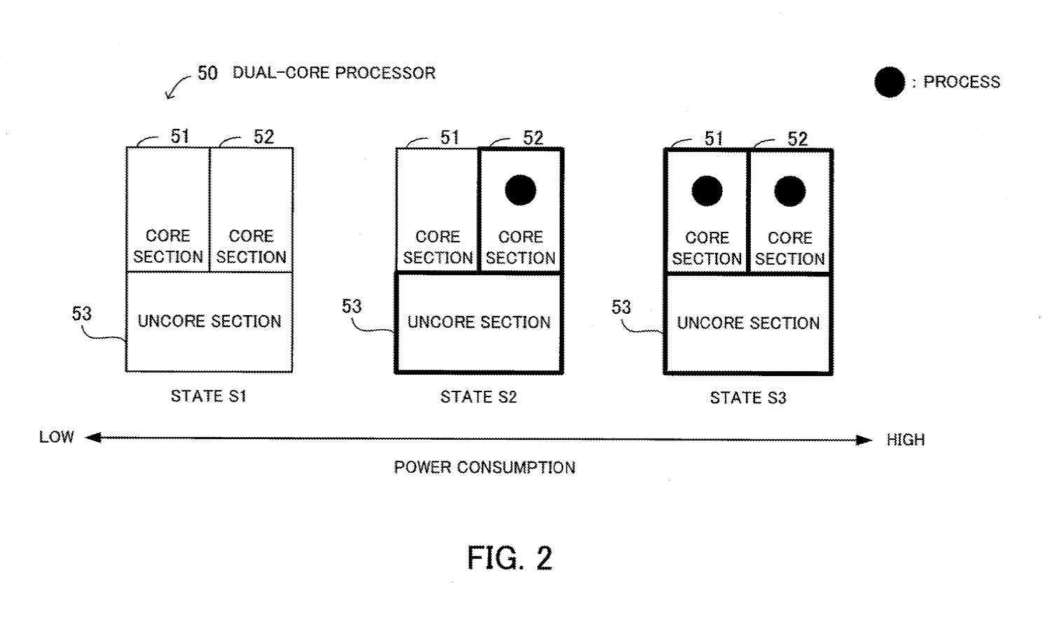

A state of consumption of power in a multi-core processor will now be described. FIG. 2 indicates a state of consumption of power in a multi-core processor. FIG. 2 indicates a state of consumption of power in a dual-core processor 50 having two core sections.

The dual-core processor 50 includes core sections 51 and 52 and an uncore section (cache memory, for example) 53. The core sections 51 and 52 share the uncore section 53.

In a state s1 a process is not assigned to the core section 51 or 52. That is to say, the core sections 51 and 52 are in an idle state (processes to be assigned are in a wait state, for example). Accordingly, the core sections 51 and 52 are in the power saving state. In addition, the core sections 51 and 52 are both in an idle state, so the uncore section 53 is also in the power saving state.

In a state s2, a process is assigned to the core section 52 and the core section 52 is executing the process. The uncore section 53 used by the core section 52 is in an active state. A process is not assigned to the core section 51 and the core section 51 is in an idle state. Therefore, only the core section 51 is in the power saving state.

In a state s3, processes are assigned to the core sections 51 and 52 and the core sections 51 and 52 are executing the processes. The uncore section 53 is in an active state. Therefore, there is no component which is in the power saving state.

Power consumption is the lowest in the state s1 of the above states s1 through s3. Power consumption is the next lowest in the state s2. Power consumption is the highest in the state s3.

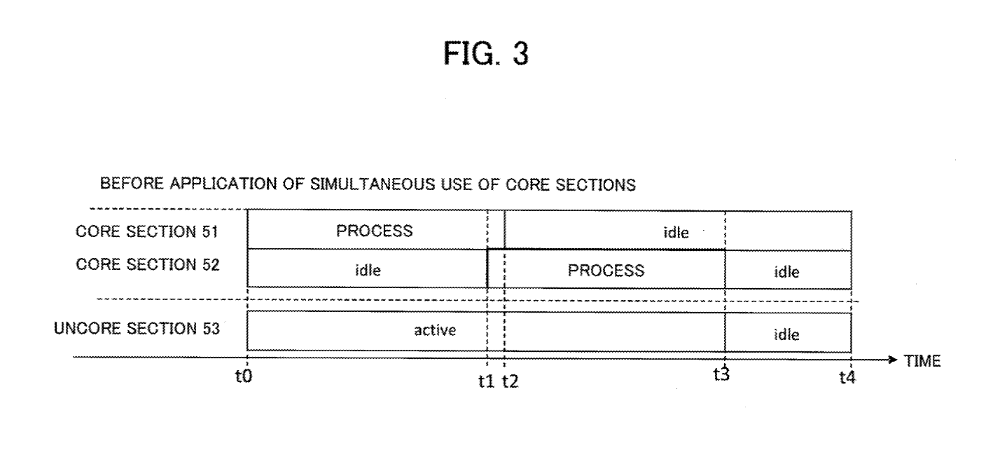

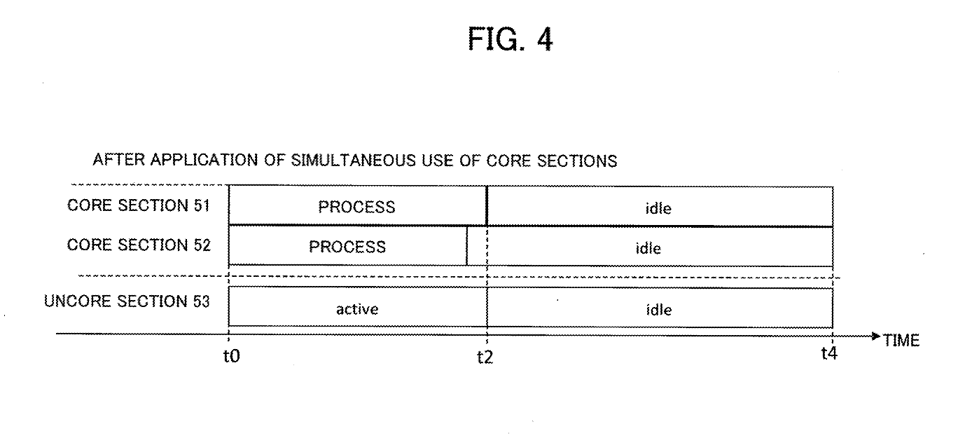

Power saving realized by the simultaneous use of the core sections (core sections execute processes at the same time) will now be described. FIGS. 3 and 4 are views for describing power saving realized by the simultaneous use of core sections. FIG. 3 indicates a state before the application of the simultaneous use of the core sections and FIG. 4 indicates a state after the application of the simultaneous use of the core sections:

In FIG. 3, the core section 51 executes a process from time t0 to time t2 and the core section 52 pexecutes a process from time t1 to time t3. When one of the core sections 51 and 52 which share the uncore section 53 operates, the uncore section 53 is in an active state. Therefore, in this example, the uncore section 53 is in an active state from the time t0 to the time t3.

In FIG. 4, the core section 51 executes the process from the time t0 to the time t2 and the core section 52 executes the process in the range of the time t0 to the time t2. The process executed by the core section 52 has terminated at the time t2 when the process executed by the core section 51 terminates. Accordingly, the core sections 51 and 52 are both in an idle state from the time t2 on.

As a result, the uncore section 53 is in the power saving state from the time t2 on. Compared with the case of FIG. 3, it is possible to keep the uncore section 53 in the power saving state for a long time. By simultaneously using the core sections in this way, it is possible to keep the uncore section in the power saving state for a longer time.

Control of timing at which a process is executed will now be described. In order to simultaneously use core sections in the above way, timing at which a process is executed is controlled. That is to say, in a period in which one core section is operating, another core section executes a process.

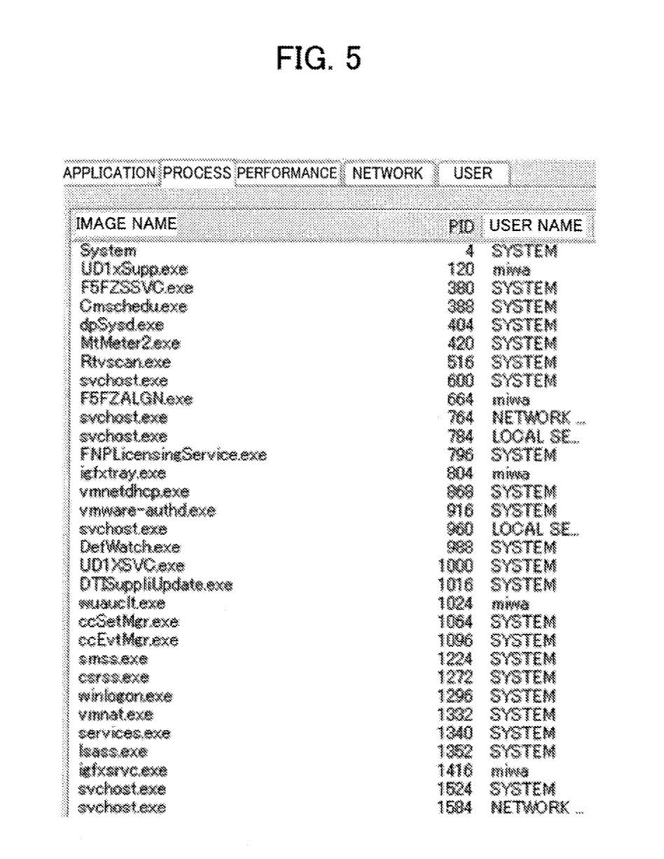

FIG. 5 is an example of a process in a desktop environment. As can be seen from FIG. 5, for example, there are various user processes and system processes in a desktop environment. These processes are executed at their respective timing.

In order to simultaneously use core sections, the above timing is controlled. Of these processes, user processes are executed at their respective timing by a user. Accordingly, it is difficult to control timing at which the user processes are executed.

On the other hand, system processes include a virus scan process and a process for performing indexing for a high-speed file search (hereinafter referred to as assist processes).

Such an assist process is started when a system is in an idle state or when a condition under which the system shifts to an idle state is met. A condition under which the system shifts to an idle state is as follows. For example, there is no process in an executable state for which the immediate beginning of execution is required. An assist process is executed according to a situation under which the system operates. There is no severe restriction on timing at which an assist process is executed. Accordingly, it is possible to control timing at which an assist process is executed.

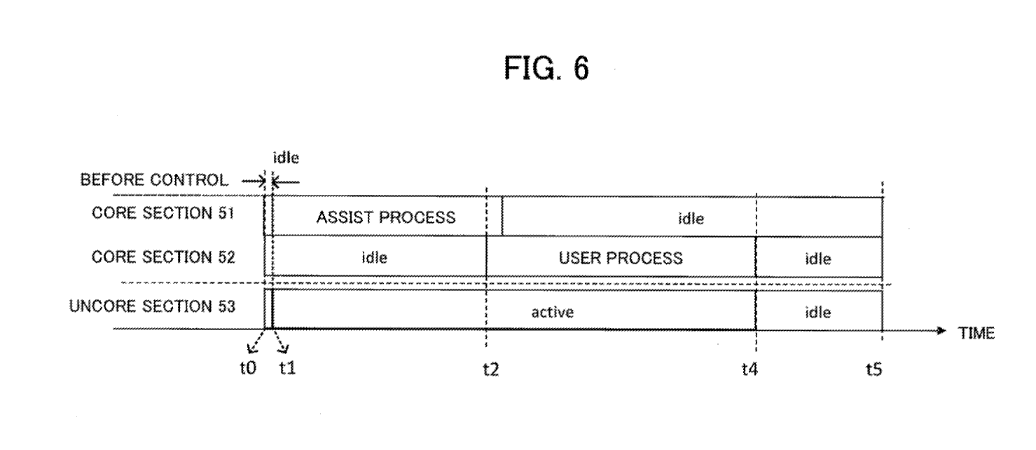

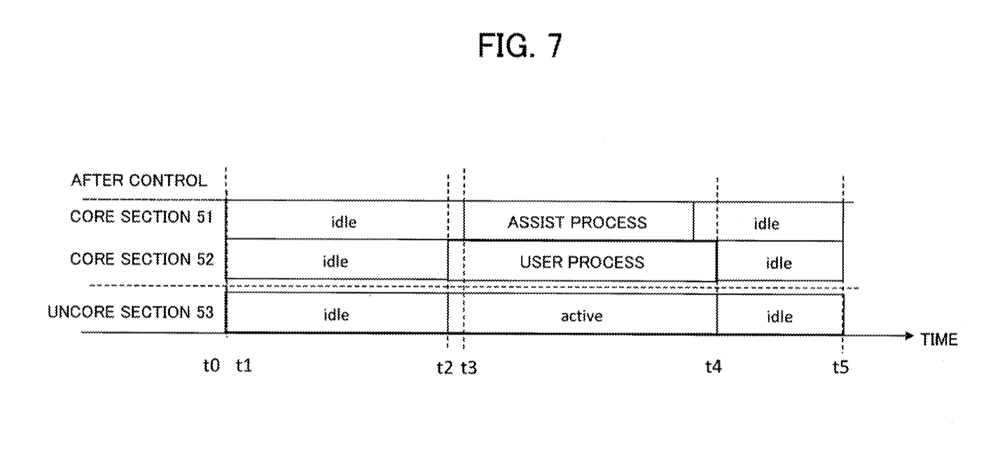

FIGS. 6 and 7 are views for describing control of timing at which an assist process is executed. FIG. 6 indicates a state before control of timing at which the assist process is executed, and FIG. 7 indicates a state after control of timing at which the assist process is executed.

In FIG. 6, the core section 51 is in an idle state from time t0 to time t1 and executes the assist process from the time t1. The core section 52 executes a user process from time t2 to time t4. In addition, the uncore section 53 is in an active state from the time t1 to the time t4.

In FIG. 7, the core section 52 executes the user process from the time t2 to the time t4. The core section 51 executes the assist process at timing at which the core section 51 confirms that the user process is executed at time t3. As a result, a period for which the core sections 51 and 52 are in an idle state is long, compared with the case of FIG. 6. Accordingly, it is possible to keep the uncore section 53 in the power saving state for a longer time.

By controlling timing at which the assist process is executed, as has been described, the plurality of core sections are used simultaneously and power saving is realized.

Process scheduling performed at the time of controlling timing at which a process is executed will now be described. The process scheduling means performing scheduling for executing, at the time of detecting that a process (hereinafter referred to as an ordinary process) other than an assist process is being executed, an assist process as well. The assist process corresponds to the above first process and the ordinary process corresponds to the above second process.

However, if a shared resource (such as a memory or a disk) is used for executing the assist process and the ordinary process and resource contention occurs, then the execution of the assist process is stopped and the assist process is returned to an executable state. The reason for this is that if resource contention occurs, process execution time lengthens.

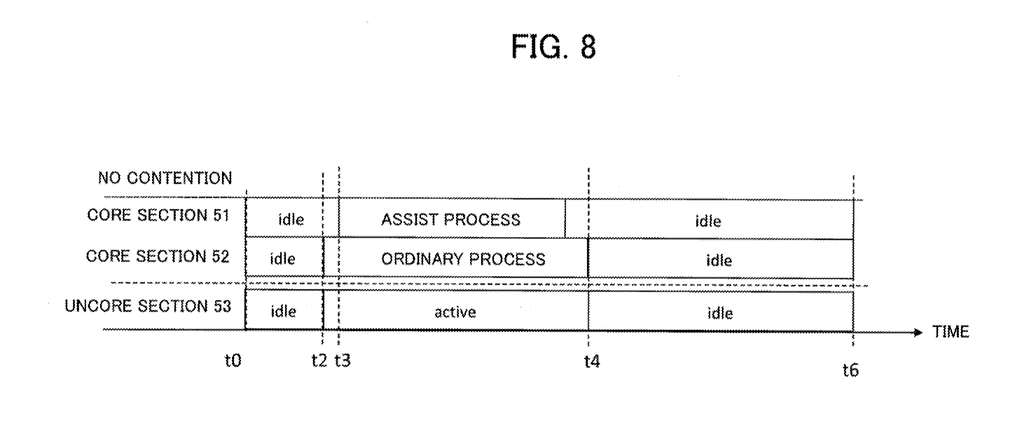

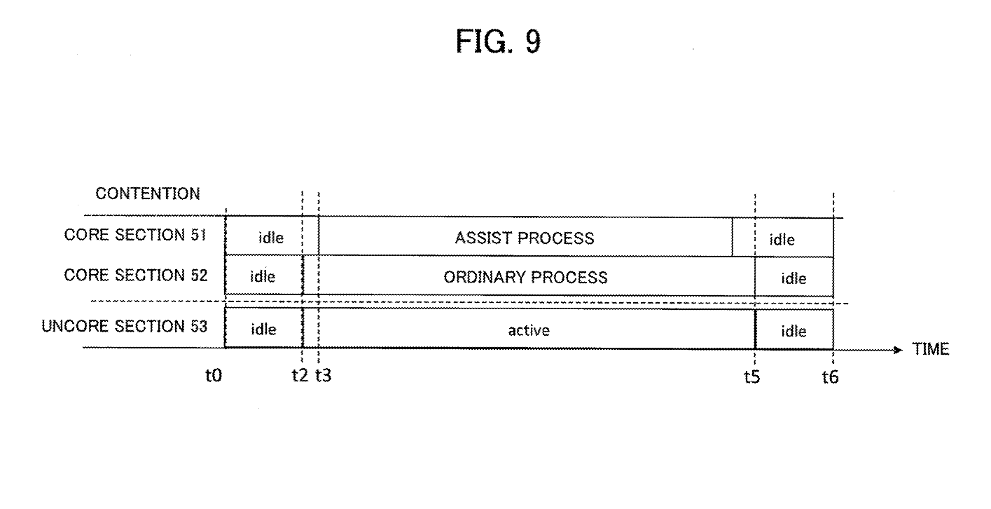

FIGS. 8 and 9 are views for describing the state of deterioration in performance at the time of the occurrence of resource contention. FIG. 8 indicates a case where resource contention does not occur, and FIG. 9 indicates a case where resource contention occurs.

In FIG. 8, it is assumed that when the core sections 51 and 52 execute an assist process and an ordinary process respectively, the core sections 51 and 52 do not use a shared resource. In this case, the core section 52 executes the ordinary process from time t2 to time t4. The core section 51 executes the assist process at timing at which the core section 51 confirms that the ordinary process is executed at time t3. The uncore section 53 is in an active state from the time t2 to the time t4.

In FIG. 9, it is assumed that the core sections 51 and 52 execute an assist process and an ordinary process, respectively, by the use of a shared resource. In this case, the core section 52 executes the ordinary process from time t2 to time t5. The core section 51 executes the assist process at timing at which the core section 51 confirms that the ordinary process is executed at time t3. The uncore section 53 is in an active state from the time t2 to the time t5.

In FIG. 8, the shared resource is not used for executing the assist process and the ordinary process. Accordingly, time taken to execute each process is the same with a case where the assist process and the ordinary process are not executed at the same time. In FIG. 9, on the other hand, the shared resource is used for executing the assist process and the ordinary process. That is to say, the assist process and the ordinary process are executed at the same time and resource contention occurs. As a result, time taken to execute each process lengthens.

For example, it is assumed that a plurality of processes for transferring data from a memory are executed at the same time. Data is transferred from the memory in the plurality of processes, so transfer wait time lengthens.

As indicated in FIG. 9, time taken to execute each process lengthens. As a result, time for which the uncore section 53 is in an active state lengthens. Accordingly, the effect of power saving cannot be achieved by the simultaneous use of the core sections.

Therefore, if an assist process is executed while an ordinary process is being executed, a resource on which a load is applied by each process is examined in advance. If resource contention does not occur, then the assist process is executed.

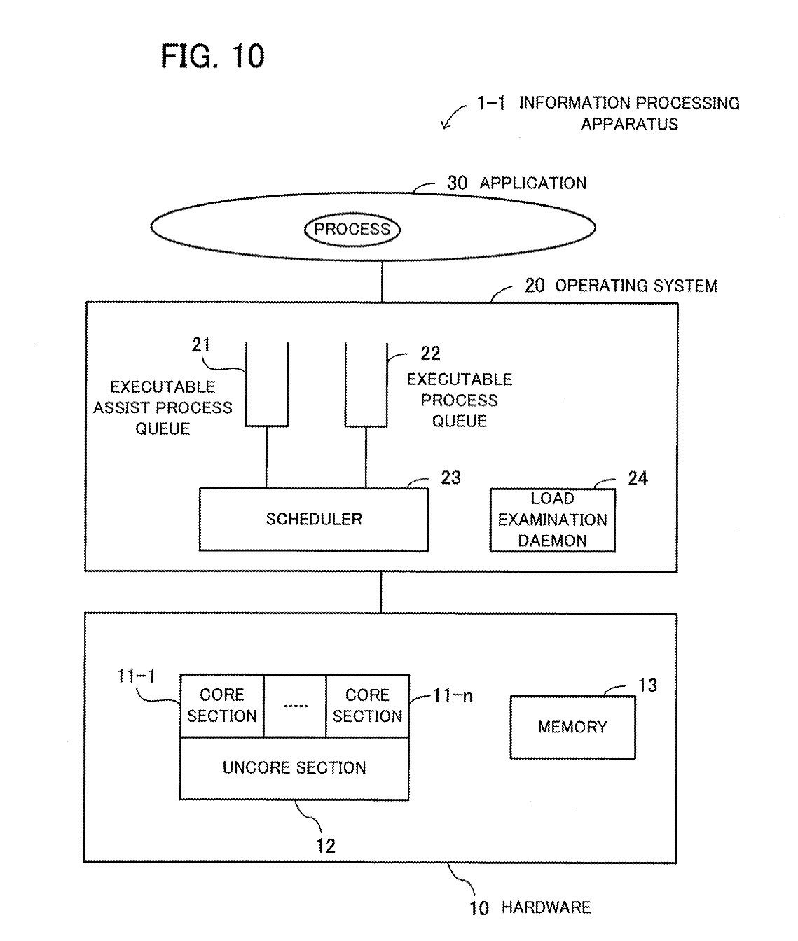

An example of the structure of the information processing apparatus 1 will now be described. FIG. 10 is an example of the structure of the information processing apparatus. An information processing apparatus 1-1 includes hardware 10, an operating system 20, and an application 30.

The hardware 10 includes core sections 11-1 through 11-n, an uncore section 12, and a memory 13. The operating system 20 includes an executable assist process queue 21, an executable process queue 22, a scheduler 23, and a load examination daemon (corresponding to a detection section) 24. The application 30 includes a process.

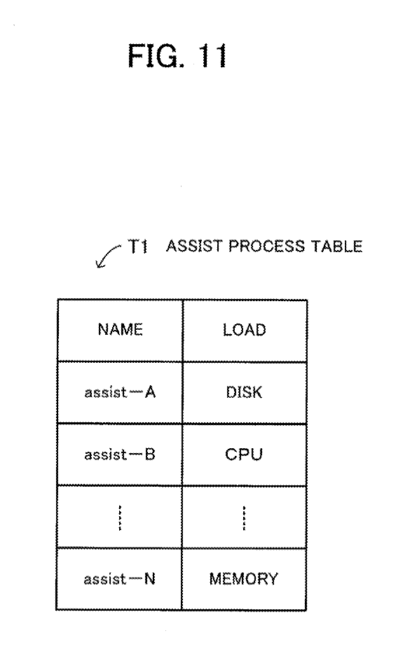

An assist process table and an ordinary process table will now be described. FIG. 11 is an example of the structure of an assist process table. An assist process table T1 is a table in which an assist process name and the attribute of a load are registered, and is held in, for example, a table management area of the memory 13.

In the example of FIG. 11, “assist-A” and “disk” are registered in Assist Process Name and Load columns. This indicates that when the assist process “assist-A” is executed, a load on a disk as a resource is the heaviest (disk is used most frequently).

Furthermore, “assist-B” and “CPU” are registered in the Assist Process Name and Load columns. This indicates that when the assist process “assist-B” is executed, a load on a CPU as a resource is the heaviest.

In addition, “assist-N” and “memory” are registered in the Assist Process Name and Load columns. This indicates that when the assist process “assist-N” is executed, a load on a memory as a resource is the heaviest.

The scheduler 23 uses the assist process table T1 for determining whether or not a target assist process is an assist process the timing of the execution of which may be controlled. In addition, the assist process table T1 is used for determining whether or not resource contention occurs at the time of executing an ordinary process and an assist process at the same time. It is possible to acquire the assist process table T1 by, for example, inquiring of a dedicated server.

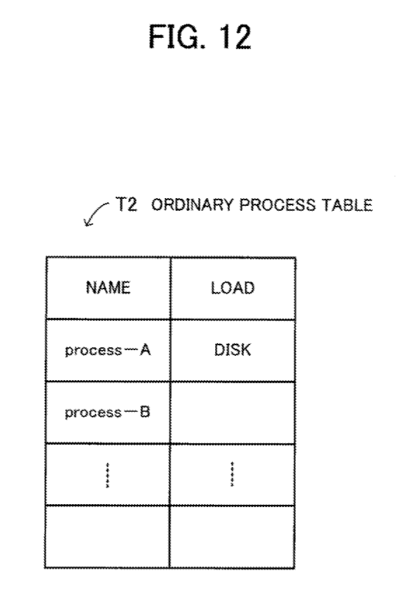

FIG. 12 is an example of the structure of an ordinary process table. An ordinary process table T2 is a table in which an ordinary process name and the attribute of a load are registered, and is held in, for example, the table management area of the memory 13.

In the example of FIG. 12, “process-A” and “disk” are registered in Ordinary Process Name and Load columns. This indicates that when the ordinary process “process-A” is executed, a load on a disk as a resource is the heaviest (disk is used most frequently).

The scheduler 23 uses the ordinary process table T2 for referring to a load corresponding to an ordinary process which is being executed (name of a process to be executed is entered by the scheduler 23).

Examination of the type of a load will now be described. The type of a load is determined by resource usage which can be acquired by a task manager or the like. In addition, the load examination daemon 24 regularly makes this examination of the type of a load and updates the ordinary process table T2 by entering the type of a load.

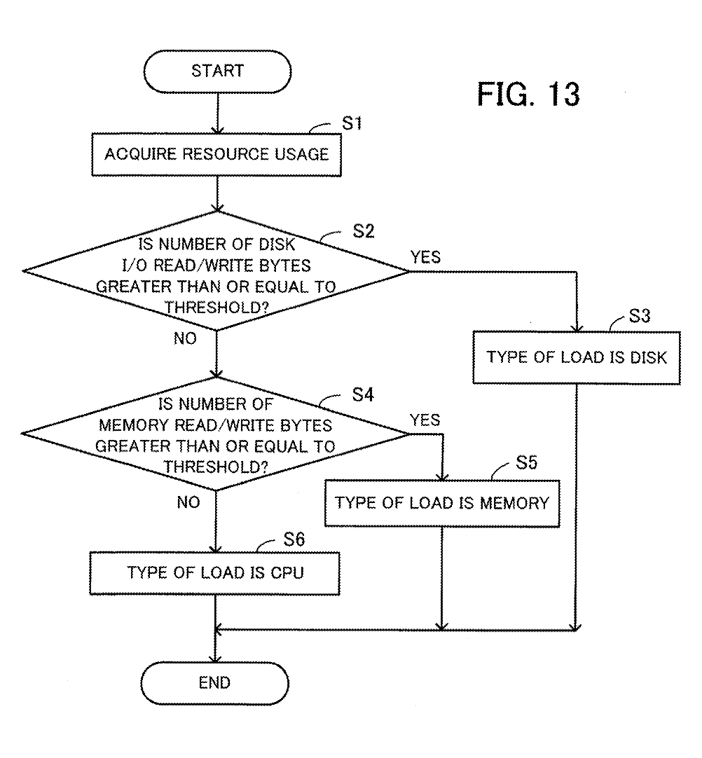

FIG. 13 indicates a flow of examination of the type of a load.

(S1) The load examination daemon 24 acquires resource usage.

(S2) The load examination daemon 24 determines whether or not the number of disk input-output read-write bytes is greater than or equal to a threshold. If the number of disk input-output read-write bytes is greater than or equal to the threshold, then step S3 is performed. If the number of disk input-output read-write bytes is smaller than the threshold, then step S4 is performed.

(S3) The load examination daemon 24 and the scheduler 23 determine that the type of a load is a disk.

(S4) The load examination daemon 24 determines whether or not the number of memory read-write bytes is greater than or equal to a threshold. If the number of memory read-write bytes is greater than or equal to the threshold, then step S5 is performed. If the number of memory read-write bytes is smaller than the threshold, then step S6 is performed.

(S5) The load examination daemon 24 and the scheduler 23 determine that the type of a load is a memory.

(S6) The load examination daemon 24 and the scheduler 23 determine that the type of a load is a CPU.

An algorithm for process scheduling by the scheduler 23 will now be described. In order to manage assist processes, the information processing apparatus 1-1 includes the executable assist process queue 21 which stores and manages assist processes in an executable state.

With ordinary process scheduling, on the basis of scheduling such as a timer interruption which occurs every constant period, an ordinary process is taken out of the executable process queue 22 which stores ordinary processes in an executable state and an execution right is given thereto.

With assist process scheduling, on the other hand, if an execution right is given to an ordinary process and there is a core section in an idle state to which a task is not assigned, an assist process is taken out of the executable assist process queue 21 and an execution right is also given thereto.

If an ordinary process is stored in the executable process queue 22, then the ordinary process is taken out of the executable process queue 22 in preference to an assist process to make an unused core section execute it.

As stated above, in addition to the executable process queue 22 which stores ordinary processes, the operating system 20 includes the executable assist process queue 21 which stores and manages assist processes.

If an execution right is given to an ordinary process and there is a core section in an idle state, then an assist process is taken out of the executable assist process queue 21 and an execution right is also given thereto.

As a result, timing at which an assist process is executed is controlled and the core sections 11-1 through 11-n can execute processes at the same time. Accordingly, power saving can be realized.

On the other hand, if there is no ordinary process in an executable state and the executable assist process queue 21 stores assist processes the number of which corresponds to that of core sections in an idle state, then execution rights are given in block to these assist processes.

If the executable process queue 22 does not store an ordinary process and the executable assist process queue 21 stores assist processes the number of which corresponds to that of core sections in an idle state, then execution rights are given in block to these assist processes in this way.

As a result, even if there is no executable ordinary process, execution rights are given to assist processes the number of which corresponds to that of core sections in an idle state. Therefore, the core sections 11-1 through 11-n can execute processes at the same time and power saving can be realized.

If an ordinary process which is being executed simultaneously with an assist process terminates and there is another ordinary process in an executable state, then this ordinary process is executed so that the processes will be executed simultaneously. If there is no ordinary process in an executable state and there is an assist process in an executable state, then this assist process is executed. If there is no process to be assigned, then an assist process which is being executed is returned to an executable state.

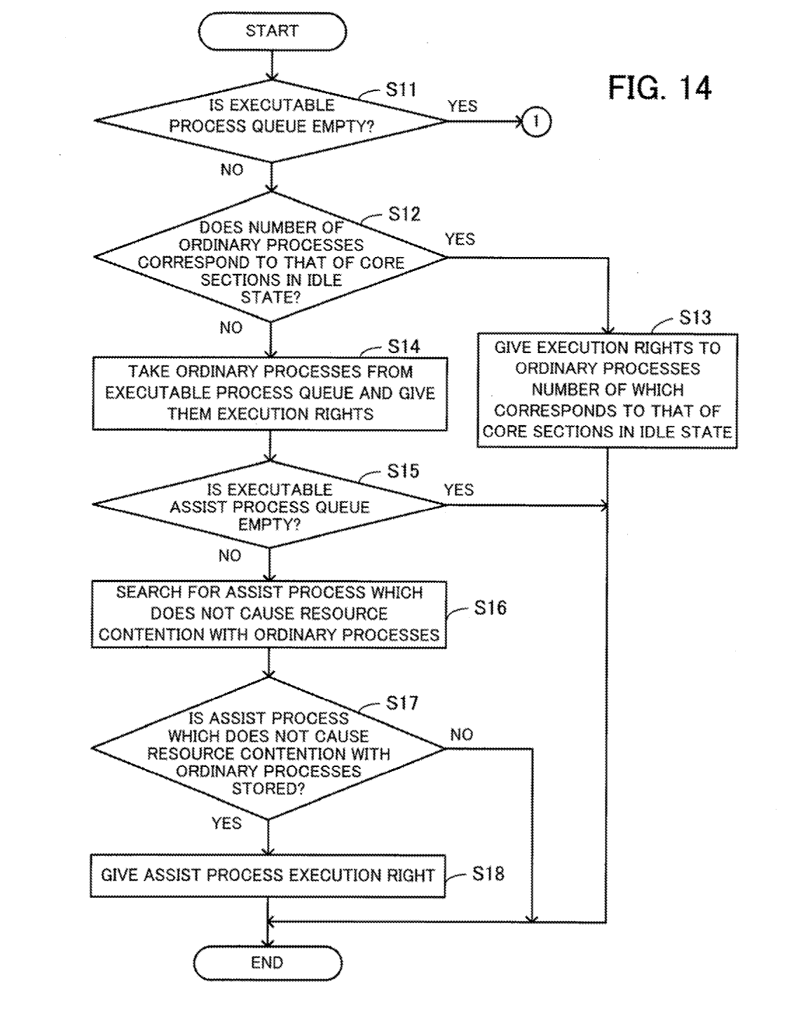

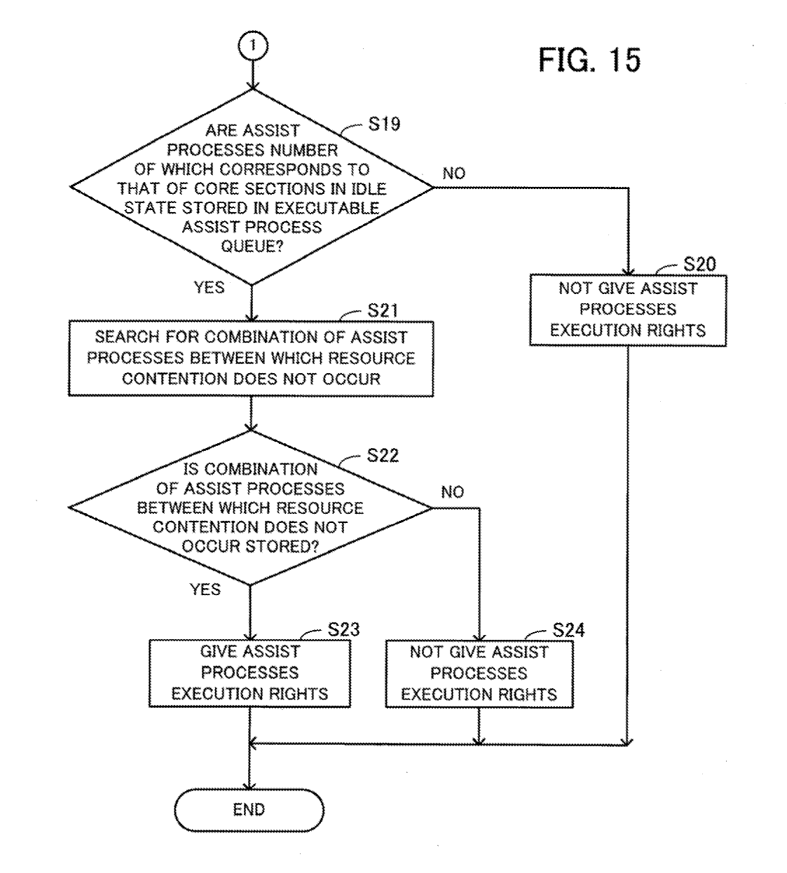

FIGS. 14 and 15 indicate a flow of scheduling. (S11) The scheduler 23 determines whether or not the executable process queue 22 is empty. If the executable process queue 22 is not empty, then the scheduler 23 proceeds to step S12. If the executable process queue 22 is empty, then the scheduler 23 proceeds to step S19.

(S12) The scheduler 23 determines whether or not the number of ordinary processes stored in the executable process queue 22 corresponds to that of core sections which are currently in an idle state. If the number of ordinary processes stored in the executable process queue 22 corresponds to that of core sections which are currently in an idle state, then the scheduler 23 proceeds to step S13. If the number of ordinary processes stored in the executable process queue 22 does not correspond to that of core sections which are currently in an idle state, then the scheduler 23 proceeds to step S14.

(S13) The scheduler 23 takes ordinary processes which are stored in the executable process queue and the number of which corresponds to that of core sections that are currently in an idle state, and gives them execution rights.

(S14) The scheduler 23 takes ordinary processes which are stored in the executable process queue 22 and the number of which is smaller than that of core sections that are currently in an idle state, and gives them execution rights.

(S15) The scheduler 23 determines whether or not the executable assist process queue 21 is empty. If the executable assist process queue 21 is not empty, then the scheduler 23 proceeds to step S16. If the executable assist process queue 21 is empty, then the scheduler 23 terminates the scheduling.

(S16) The scheduler 23 searches the executable assist process queue 21 for an assist process which does not cause resource contention with the ordinary processes to which execution rights are given in step S14.

(S17) The scheduler 23 determines whether or not there is an assist process which does not cause resource contention with the ordinary processes. If there is an assist process which does not cause resource contention with the ordinary processes, then the scheduler 23 proceeds to step S18. If there is no assist process which does not cause resource contention with the ordinary processes, then the scheduler 23 terminates the scheduling.

(S18) The scheduler 23 takes out of the executable assist process queue 21 an assist process which does not cause resource contention with the ordinary processes, and gives it an execution right.

(S19) The scheduler 23 determines whether or not assist processes the number of which corresponds to that of core sections that are currently in an idle state are stored in the executable assist process queue 21. If assist processes the number of which corresponds to that of core sections that are currently in an idle state are not stored in the executable assist process queue 21, then the scheduler 23 proceeds to step S20. If assist processes the number of which corresponds to that of core sections that are currently in an idle state are stored in the executable assist process queue 21, then the scheduler 23 proceeds to step S21.

(S20) The scheduler 23 does not give the assist processes execution rights.

(S21) The scheduler 23 searches the assist processes which are stored in the executable assist process queue 21 and the number of which corresponds to that of core sections that are currently in an idle state for a combination of assist processes between which resource contention does not occur.

(S22) The scheduler 23 determines whether or not there is a combination of assist processes between which resource contention does not occur. If there is a combination of assist processes between which resource contention does not occur, then the scheduler 23 proceeds to step S23. If there is no combination of assist processes between which resource contention does not occur, then the scheduler 23 proceeds to step S24.

(S23) The scheduler 23 takes out of the executable assist process queue 21 a combination of assist processes between which resource contention does not occur, and gives them execution rights.

(S24) The scheduler 23 does not give the assist processes execution rights.

The contents of a scheduling flow are not limited to those indicated in FIGS. 14 and 15. There may be various scheduling flows.

In steps S19 and S20 indicated in FIG. 15, for example, if assist processes the number of which corresponds to that of core sections that are currently in an idle state are not stored in the executable assist process queue 21, then “the scheduler 23 does not give the assist processes execution rights”. However, the following step may be adopted. If there are a plurality of assist processes, then the scheduler 23 assigns execution rights.

For example, it is assumed that a processor includes four core sections. Furthermore, at the time when step S19 indicated in FIG. 15 is performed, it is assumed that there is no ordinary process, that the four core sections are in an idle state, and that three assist processes are queued. According to the flow chart of FIG. 15, the assist processes are not executed. However, if the three assist processes are queued, control may be exercised so as to simultaneously execute these three assist processes.

Determination of resource contention will now be described. If an assist process and an ordinary process are executed simultaneously or if a plurality of assist processes are executed simultaneously, whether or not resource contention occurs is determined.

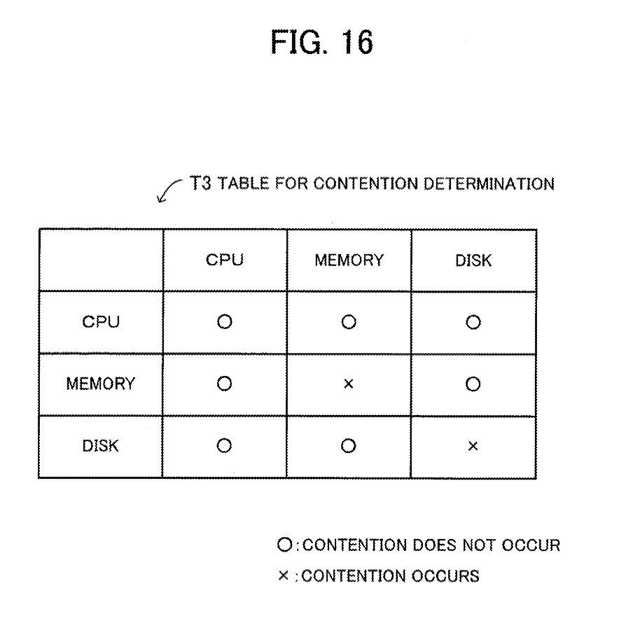

FIG. 16 is an example of the structure of a table for contention determination. A table for contention determination T3 is a table in which a pattern of the type of a load of each process which causes resource contention is registered, and is held in, for example, the table management area of the memory 13.

In FIG. 16, “o” indicates that resource contention does not occur, and “x” indicates that resource contention occurs.

In the table for contention determination T3, if the type of a load of one process is a CPU and the type of a load of the other process is the CPU, a memory, or a disk, then resource contention does not occur.

Furthermore, if the type of a load of one process is the memory and the type of a load of the other process is also the memory, then resource contention occurs. If the type of a load of one process is the memory and the type of a load of the other process is the CPU or the disk, then resource contention does not occur.

In addition, if the type of a load of one process is the disk and the type of a load of the other process is also the disk, then resource contention occurs. If the type of a load of one process is the disk and the type of a load of the other process is the CPU or the memory, then resource contention does not occur.

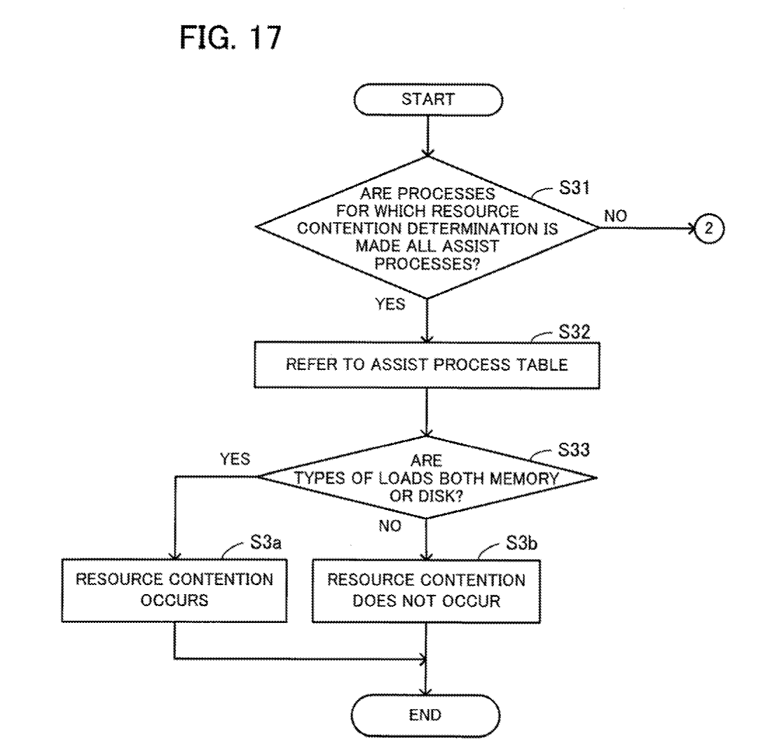

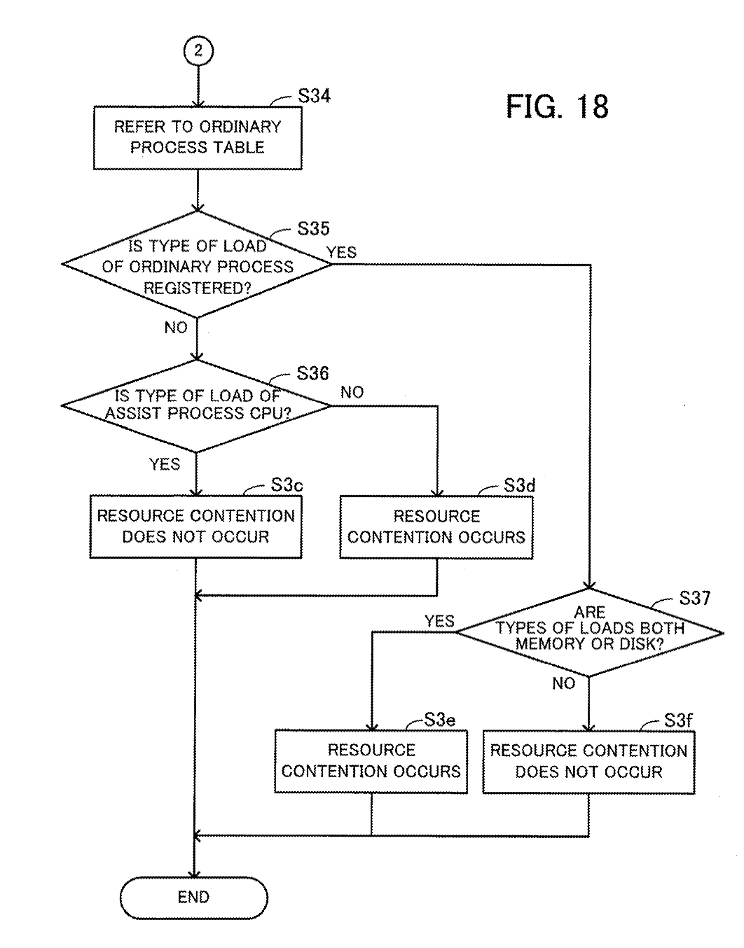

FIGS. 17 and 18 indicate a flow of operation performed in a resource contention determination process. (S31) The scheduler 23 determines whether or not processes for which resource contention determination is made are all assist processes. If processes for which resource contention determination is made are all assist processes, then the scheduler 23 proceeds to step S32. If processes for which resource contention determination is made include an ordinary process, then the scheduler 23 proceeds to step S34.

(S32) The scheduler 23 refers to the assist process table T1 and recognizes the types of loads of the assist processes for which resource contention determination is made.

(S33) The scheduler 23 refers to the table for contention determination T3 and determines whether or not resource contention occurs. To be concrete, the scheduler determines whether or not the types of the loads of both the assist processes are both the memory or the disk. If the types of the loads of both the assist processes are both the memory or the disk, then the scheduler 23 proceeds to step S3a. If the types of the loads of both the assist processes are not both the memory or the disk, then the scheduler 23 proceeds to step S3b.

(S3a) The scheduler 23 recognizes that resource contention occurs.

(S3b) The scheduler 23 recognizes that resource contention does not occur.

(S34) The processes for which resource contention determination is made include an ordinary process, so the scheduler 23 refers to the ordinary process table T2 in order to recognize the type of a load of the ordinary process for which resource contention determination is made.

(S35) The scheduler 23 determines whether or not the type of the load of the ordinary process for which resource contention determination is made is registered in the ordinary process table T2. If the type of the load of the ordinary process for which resource contention determination is made is not registered in the ordinary process table T2, then the scheduler 23 proceeds to step S36. If the type of the load of the ordinary process for which resource contention determination is made is registered in the ordinary process table T2, then the scheduler 23 proceeds to step S37.

(S36) The scheduler 23 determines whether or not the type of a load of an assist process included in the processes for which resource contention determination is made is the CPU. If the type of a load of the assist process included in the processes for which resource contention determination is made is the CPU, then the scheduler 23 proceeds to step S3c. If the type of a load of the assist process included in the processes for which resource contention determination is made is not the CPU, then the scheduler 23 proceeds to step S3d.

(S3c) The scheduler 23 recognizes that resource contention does not occur. If the type of a load of the assist process is the CPU, then resource contention does not occur, on the basis of the contents registered in the table for contention determination T3, whether the type of the load of the other ordinary process is the CPU, the memory, or the disk. Therefore, the scheduler 23 recognizes that resource contention does not occur.

(S3d) There is a possibility that resource contention occurs. Accordingly, the scheduler 23 recognizes that resource contention occurs.

If the type of a load of the assist process is not the CPU and the type of the load of the other ordinary process is the CPU, then resource contention does not occur on the basis of the contents registered in the table for table for contention determination T3. However, if the type of a load of the assist process is not the CPU and the type of the load of the other ordinary process is the memory or the disk, then resource contention may occur. In this state the type of the load of the other ordinary process is unknown, so there is a possibility that resource contention occurs. Accordingly, the scheduler 23 recognizes that resource contention occurs.

(S37) The scheduler 23 refers to the table for contention determination T3 and determines whether or not resource contention occurs. To be concrete, the scheduler 23 determines whether or not the types of loads of both the processes are both the memory or the disk. If the types of loads of both the processes are both the memory or the disk, then the scheduler 23 proceeds to step S3e. If the types of loads of both the processes are not both the memory or the disk, then the scheduler 23 proceeds to step S3f.

(S3e) The scheduler 23 recognizes that resource contention occurs.

(S3f) The scheduler 23 recognizes that resource contention does not occur.

If resource contention occurs at the time of simultaneously using the core sections, time taken to execute processes lengthens. As a result, time for which the uncore section 53 is in an active state lengthens. However, as stated above, if the scheduler 23 recognizes that contention for a resource shared at process execution time occurs, then the scheduler 23 does not give an execution right to an assist process. By doing so, the occurrence of the above phenomenon can be controlled.

In the above description the type of a load of an assist process is made clear in advance. However, there is a case where the type of a load of an ordinary process is not clear at scheduling time. Accordingly, whether or not the type of a load of an ordinary process is registered in the ordinary process table T2 is determined in step S35.

Furthermore, if the type of the load of the ordinary process is not registered in the ordinary process table T2, then the type of a load of an assist process included in processes for which resource contention determination is made is determined in step S36. If the type of the load of the assist process included in the processes for which resource contention determination is made is the CPU, then a shared resource is not used. Therefore, the determination that resource contention does not occur is made. In addition, if the type of the load of the assist process included in the processes for which resource contention determination is made is not the CPU, then the execution of the ordinary process may be influenced. Accordingly, the determination that resource contention occurs is made.

As stated above, there is a case where a resource on which a load is applied at the time of executing an ordinary process is unknown. However, if the type of a load of an assist process is not the CPU, then the determination that resource contention occurs at the time of executing the ordinary process and the assist process is made. This can reliably prevent resource contention.

As has been described in the foregoing, with the information processing apparatus 1 an assist process for which controlling execution timing is permitted is designated in advance. In the information processing apparatus 1 timing at which the assist process is executed is controlled so as to make an unused core section execute the assist process in a period in which an ordinary process other than the assist process is executed by a part of a plurality of core sections.

As a result, the uncore section 12 can be kept in the power saving state for a long time, compared with a case where the assist process is executed at any timing at idle time. Accordingly, power saving can be realized.

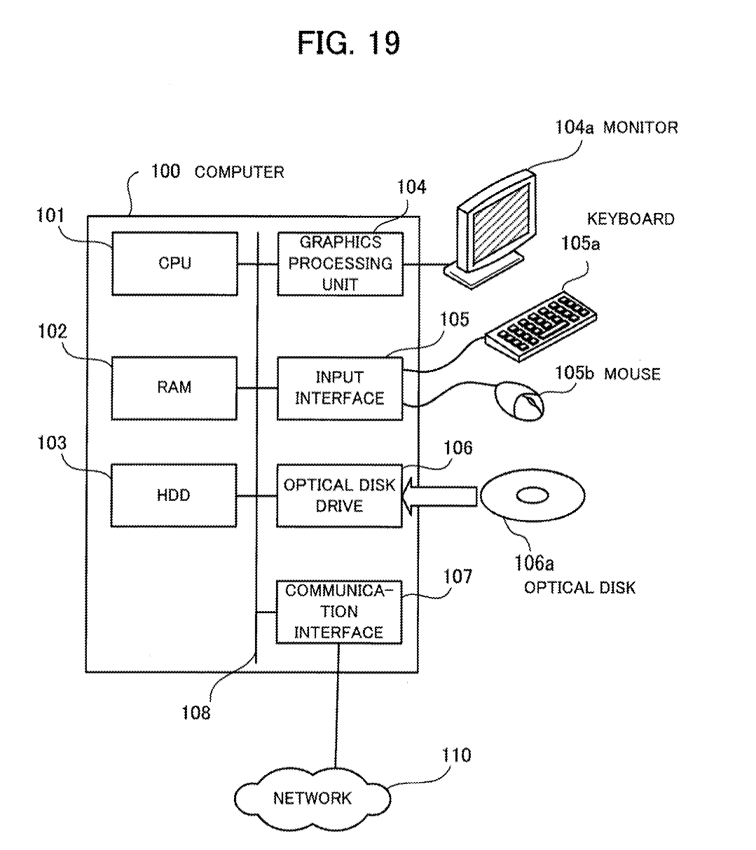

The above processing functions can be realized by a computer. FIG. 19 is an example of the hardware configuration of a computer used in this embodiment. The whole of a computer 100 is controlled by a CPU 101. A RAM 102 and a plurality of peripheral devices are connected to the CPU 101 via a bus 108.

The RAM 102 is used as main storage of the computer 100. The RAM 102 temporarily stores at least a part of an OS (Operating System) or an application program executed by the CPU 101. The RAM 102 also stores various pieces of data which the CPU 101 needs to execute a process.

The plurality of peripheral devices connected to the bus 108 include an HDD 103, a graphics processing unit 104, an input interface 105, an optical disk drive 106, and a communication interface 107.

The HDD 103 magnetically writes data to and reads out data from a built-in disk. The HDD 103 is used as auxiliary storage of the computer 100. The HDD 103 stores the OS, application programs, and various pieces of data. A semiconductor memory such as a flash memory can be used as auxiliary storage.

A monitor 104a is connected to the graphics processing unit 104. In accordance with instructions from the CPU 101, the graphics processing unit 104 displays an image on a screen of the monitor 104a. A display unit using a CRT (Cathode Ray Tube), a liquid crystal display, or the like is used as the monitor 104a.

A keyboard 105a and a mouse 105b are connected to the input interface 105. The input interface 105 transmits a signal transmitted from the keyboard 105a or the mouse 105b to the CPU 101. The mouse 105b is an example of a pointing device and another pointing device such as a touch panel, a tablet, a touch pad, or a track ball can be used.

The optical disk drive 106 reads data recorded on an optical disk 106a by the use of, for example, a laser beam. The optical disk 106a is a portable record medium on which data is recorded so that it can be read by the reflection of light. The optical disk 106a may be a DVD (Digital Versatile Disk), a DVD-RAM, a CD-ROM (Compact Disk Read Only Memory), a CD-R (Recordable)/RW(ReWritable), or the like.

The communication interface 107 is connected to a network 110. The communication interface 107 transmits data to and receives data from another computer or a communication device via the network 110.

By adopting the above hardware configuration, the processing functions in this embodiment can be realized.

According to this embodiment the power consumption of a processor can be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising one or more multi-core processors, the one or more multi-core processors performing a procedure comprising:
determining scheduling time for processes executed by a plurality of core sections included in the one or more multi-core processors; and
controlling execution timing for a first process at the scheduling time so as to make an unused core section execute the first process in a period in which a second process other than the first process is executed by a part of the plurality of core sections, controlling the execution timing for the first process being permitted.

2. The information processing apparatus according to claim 1, wherein the controlling the execution timing includes:
using a first queue for storing the first process and a second queue for storing the second process;
taking, at the time of the second process being stored in the second queue, the second process out of the second queue and making a core section execute the second process in preference to the first process; and
taking, at the time of there being a core section which is executing the second process and there being an unused core section, the first process out of the first queue and making the unused core section execute the first process.

3. The information processing apparatus according to claim 2, wherein the controlling the execution timing includes making, at the time of the second process not being stored in the second queue and the first process which is provided in plurality and a number of which corresponds to a number of unused core sections being stored in the first queue, the unused core sections execute the first processes in block.

4. The information processing apparatus according to claim 1, wherein the procedure further includes:
detecting a resource on which a load is applied at first process execution time or second process execution time; and
controlling the execution timing by stopping, at the time of recognizing that execution of the first process causes contention for a resource on which a load is applied at execution time between the first process and the second process which is being executed, the execution of the first process.

5. The information processing apparatus according to claim 4, wherein the controlling the execution timing includes determining, at the time of the resource on which a load is applied at the second process execution time being unknown and the resource on which a load is applied at the first process execution time not being a core section, that resource contention occurs at the time of executing the first process and the second process.

6. A scheduling method comprising:
determining, by a computer, scheduling time for processes executed by a plurality of core sections included in a multi-core processor; and
controlling, by the computer, execution timing for a first process at the scheduling time so as to make an unused core section execute the first process in a period in which a second process other than the first process is executed by a part of the plurality of core sections, controlling the execution timing for the first process being permitted.

7. A computer-readable storage medium storing a computer program, the computer program causing a computer to perform a procedure comprising:
determining scheduling time for processes executed by a plurality of core sections included in a multi-core processor; and
controlling execution timing for a first process at the scheduling time so as to make an unused core section execute the first process in a period in which a second process other than the first process is executed by a part of the plurality of core sections, controlling the execution timing for the first process being permitted.
